(19) United States
(12) Patent Application Publication
(10) Pub. No.: US 2007/0297375 A1
(43) Pub. Date: Dec. 27, 2007

(54) SYSTEM AND METHOD FOR DATA TRANSMISSION IN AN AD HOC COMMUNICATION NETWORK

(75) Inventors: Jeffrey D. Bonta, Arlington Heights, IL (US); Stephen P. Emeott, Rolling Meadows, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/426,705

(22) Filed: Jun. 27, 2006

(51) Int. Cl. H04Q 7/24

(52) U.S. Cl. 370/338

(57) ABSTRACT

A system and method for data transmission in an ad hoc wireless communication network is useful for improving network efficiency. The method includes determining whether both high priority data and low priority data are queued for transmission from a sending node to a receiving node (step 620). When both high priority data and low priority data are queued for transmission, the high priority data and the low priority data are aggregated in an aggregated data frame (step 625). Finally, the aggregated data frame is transmitted to the receiving node (step 630).

### FIELD OF THE INVENTION

The present invention relates generally to data transmission between wireless communication devices in an ad hoc wireless communication network. In particular, the invention relates to improving transmission efficiency of high priority and low priority data in an ad hoc wireless communication network.

### BACKGROUND OF THE INVENTION

In an ad hoc wireless communication network multiple data sessions can be in progress simultaneously and can share a single communication channel. Such multiple data sessions can be addressed to multiple destinations and can comprise a combination of data having different delivery priorities.

For example, high priority data, such as real time data, generally has fairly strict requirements regarding delivery so as to minimize latency and to maximize the Quality-of-Service (QoS) of the session. In the case of high priority Voice over Internet Protocol (VoIP) data, if delays in transmission are too large, the data can become stale and are discarded, resulting in an interruption of a voice communication channel.

In contrast, low priority data, such as non-real time data, do not generally have strict delivery requirements and modest delays in transmission are typically not problematic. “Best efforts” and “less than best efforts” delivery services are often employed for low priority data transmission.

In many ad hoc wireless communication networks there is a common problem referred to as the “hidden node” problem. A node is typically an electronic communication device, such as a mobile telephone, and the hidden node problem occurs when a receiving node is within range of two sending nodes, but each sending node cannot detect transmissions from the other sending node. Consequently, each sending node may transmit at the same time, resulting in a data collision at the destination node.

One known approach to mitigating the hidden node problem in ad hoc networking protocols employing carrier sense multiple access with collision avoidance (CSMA/CA) channel access, such as Institute of Electrical and Electronics Engineers (IEEE) 802.11 applications, is the use of Request-to-Send (RTS) and Clear-to-Send (CTS) packets. An RTS/CTS protocol communicates to all nodes within communication range of sending and receiving nodes an intention of the sending and receiving nodes to occupy a particular communication channel for a predetermined period of time. RTS and CTS packets are generally much smaller than associated non-real time data payload packets, and thus RTS and CTS packets do not generally add excessive bandwidth overhead to CSMA/CA non-real time communications. However, the size of RTS and CTS packets can be significant compared to the size of real time data packets, such as VoIP data packets. VoIP data packets are sufficiently small so that employing an RTS/CTS protocol to mitigate the hidden node problem can more than double the bandwidth requirements for sending real time data packets.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a block diagram illustrating a sequence of sub-frames in an aggregated data frame as known from the prior art.

FIG. 2 is a block diagram illustrating a structure of one of the sub-frames shown in FIG. 1 as known from the prior art.

FIG. 3 is a schematic diagram illustrating a wireless communication network, according to some embodiments of the present invention.

FIG. 4 is a block diagram illustrating communication of high and low priority data between nodes of the wireless communication network shown in FIG. 3, according to some embodiments of the present invention.

FIG. 5 is a block diagram illustrating a sequence of sub-frames in an aggregated data frame that includes both high priority data and low priority data, according to some embodiments of the present invention.

FIG. 6 is a general flow diagram illustrating a method, from the perspective of a sending node, for data transmission between the nodes of the wireless communication network shown in FIG. 3, according to some embodiments of the present invention.

FIG. 7 is a general flow diagram illustrating sub-steps of the method described in FIG. 6 for data transmission, according to some embodiments of the present invention.

FIG. 8 is a block diagram illustrating components of a node of the wireless communication network shown in FIG. 3, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to data transmission in an ad hoc wireless communication network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of data transmission in an ad hoc wireless communication network as described herein. The non-processor circuits may include, but are not limited to, a radio receiver, a radio transmitter, signal drivers, clock circuits, power source circuits, and user input devices. As such, these functions may be interpreted as steps of a method for data transmission in an ad hoc wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Institute of Electrical and Electronics Engineers (IEEE) 802.11 standards require provision for enabling an Aggregated Medium Access Control (MAC) Service Data Unit (A-MSDU). An A-MSDU comprises a frame aggregation format that allows aggregation of multiple MAC Service Data Units (MSDUs) in one MAC Protocol Data Unit (MPDU). If a sending node in an ad hoc communication network transmits an A-MSDU, a receiving node receives the A-MSDU and de-aggregates the A-MSDU into its component MSDUs. A purpose of an A-MSDU is to allow multiple MSDUs that are to be sent to a same receiving node to be aggregated and sent in a single MPDU. That improves the efficiency of a sending node's MAC layer, particularly when there are many small MSDUs, such as Transmission Control Protocol (TCP) acknowledgements. Although support at a receiving node for A-MSDUs is mandatory according to IEEE 802.11 standards, a sending node is free to use A-MSDUs or not based on information such as traffic characteristics and link conditions.

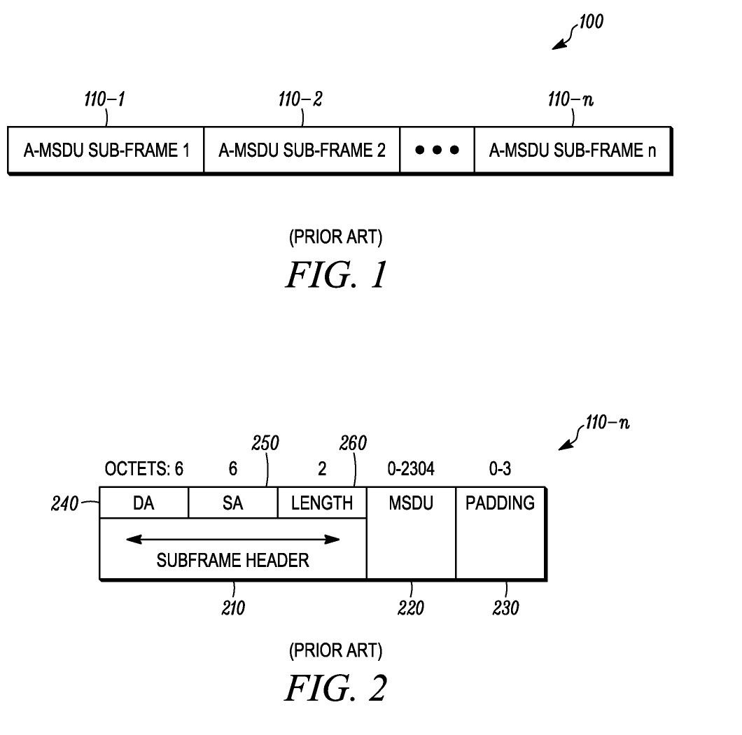

Referring to FIG. 1, a block diagram illustrates a sequence of sub-frames in an aggregated data frame, as known from the prior art. As shown, an A-MSDU 100 comprises a plurality of A-MSDU sub-frames 110-n (i.e., sub-frames 110-1, 110-2, . . . , 110-n).

Referring to FIG. 2, a block diagram illustrates a structure of one of the sub-frames shown in FIG. 1, as known from the prior art. Each A-MSDU sub-frame 110-n consists of a sub-frame header 210 followed by an MSDU 220, and typically 0-3 bytes of padding 230. Each sub-frame 110-n, except for the last sub-frame, is padded such that its length is a multiple of 4 bytes. The last sub-frame has no padding. The sub-frame header 210 contains three fields: a Destination Address (DA) field 240, a Source Address (SA) field 250 and a Length field 260. The Length field contains the length in bytes of the MSDU 220.

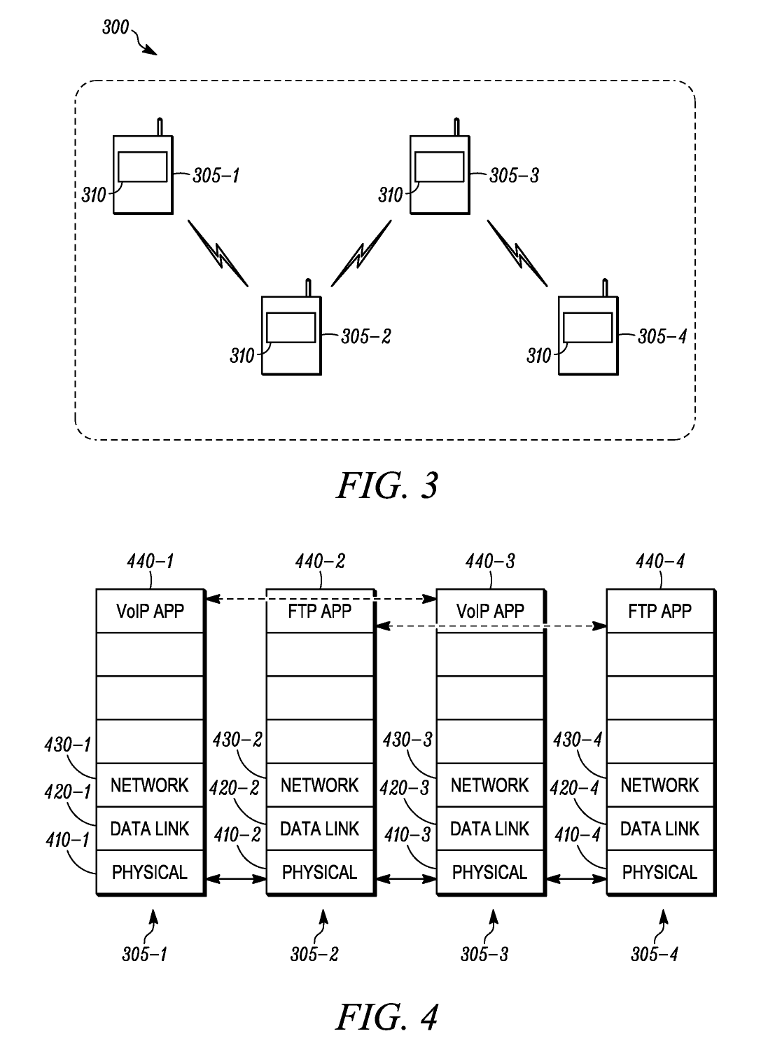

Referring to FIG. 3, a schematic diagram illustrates a wireless communication network 300, according to some embodiments of the present invention. The network 300 includes a plurality of nodes 305-n (i.e., nodes 305-1 to 305-4) that function as wireless communication devices. According to some embodiments of the present invention, the network 300 can comprise a Mobile Ad Hoc Network (MANET). MANETs are based on autonomous collections of mobile users who communicate with each other over wireless links having limited bandwidths. MANETs are usually temporary packet radio networks which do not involve significant supporting infrastructure and in which the user nodes themselves perform routing functions. As described in more detail below, each node 305-n comprises computer readable program code components 310 for data transmission in accordance with the teachings of the present invention.

Referring to FIG. 4, a schematic diagram illustrates communications between the nodes 305-n of the wireless communication network 300 shown in FIG. 3, according to some embodiments of the present invention. According to an Open System Interconnection (OSI) model, each node 305-n comprises a plurality of communication layers including a physical layer 410-n, a data link layer 420-n, a network layer 430-n and an application layer 440-n. The physical layers 410-n of nodes 305-n support wireless ad hoc communication using an IEEE 802.11 standard air interface definition.

Consider an example where the following circumstances exist. Due to the locations of the nodes 305-n and the propagation conditions between them: a) node 305-1 can communicate directly with only node 305-2, b) node 305-2 can communicate directly with only nodes 305-1 and 305-3, c) node 305-3 can communicate directly with only nodes 305-2 and 305-4, and d) node 305-4 can communicate directly with only node 305-3. Thus, in this example, node 305-1 cannot communicate directly with node 305-3 or 305-4; and node 305-2 cannot communicate directly with node 305-4.

Utilizing an ad hoc communication protocol, each node 305-n can communicate indirectly with all other nodes 305-n. Indirect communication is facilitated by relay of communications from one node 305-n to another. For example, node 305-1 can indirectly communicate with node 305-3 by having node 305-2 relay a communication from node 305-1 to node 305-3. Likewise, node 305-2 can indirectly communicate with node 305-4 by having node 305-3 relay a communication from node 305-2 to node 305-4. Thus data can be received at a node 305-n from different sending nodes 305-n with an expectation to deliver the data to different destination nodes 305-n, and a sending node 305-n can be one hop or multiple hops from a destination node 305-n.

Consider further that the nodes 305-1 and 305-3 have high priority applications in the form of Voice over Internet Protocol (VoIP) applications 440-1 and 440-3, respectively, that are generating high priority data in the form of speech frames for transmission between the nodes 305-1 and 305-3. Communications concerning the speech frames are represented by the dashed double-headed arrow between the VoIP applications 440-1 and 440-3. Consider also that the nodes 303-2 and 303-4 have low priority applications in the form of File Transfer Protocol (FTP) applications 440-2 and 440-4, respectively, that are processing low priority data in the form of a file being transferred from node 305-2 to node 305-4 utilizing a Transmission Control Protocol/Internet Protocol (TCP/IP). Communications concerning the file transfer are represented by the dashed double-headed arrow between the File Transfer Protocol (FTP) applications 440-2 and 440-4.

In this example, the VoIP applications 440-1 and 440-3 in nodes 305-1 and 305-3 are each generating high priority data in the form of real time data packets at a relatively high rate, such as every 20 milliseconds. The FTP application 440-2 in node 305-2 is a low-priority, non-real time application, which is making a best efforts transfer of low-priority data to node 305-4 at a relatively low rate, which is regulated by TCP acknowledgements received from node 305-4. As known to those skilled in the art, high priority data in the form of VoIP MSDU packets may be only 40 bytes in length, while low-priority data in the form of FTP MSDU packets may range from 500 to 1500 bytes in length.

The VoIP applications 440-1 and 440-3 require a higher Quality of Service (QoS) than the FTP applications 440-2, 440-4 and, accordingly, the Medium Access Control (MAC) layer in the data link layers 420-n gives VoIP packets a higher priority for transmission. The prioritization of the data is managed by the MAC layer with queues for each QoS level. For example, a high priority queue can exist for high priority data, such as the VoIP data packets, and a low priority queue can exist for low-priority data, such as the FTP data packets.

In the example shown in FIG. 4, the VoIP application 440-1 in node 305-1 generates high priority data in the form of a Service Data Unit (SDU) containing a VoIP frame addressed to node 305-3. Upon receiving the high priority data, the routing protocol of the data link layer 420-1 of node 305-1 determines that there is a route to the destination node 305-3. The route requires that the high priority data be relayed through node 305-2. Therefore, the routing protocol of the data link layer 420-1 delivers the high priority data to the MAC layer in node 305-1 and requests delivery of the high priority data to node 305-3 through node 305-2. The MAC layer in the data link layer 420-1 of node 305-1 then buffers the high priority data in a high priority traffic queue, which, in the present example, is a real time traffic queue.

The MAC layer in the data link layer 420-1, in concert with the physical layer 410-1, determines that the communication channel between the nodes 305-1 and 305-2 is not busy and generates a Request-To-Send (RTS) packet for delivery to node 305-2. The RTS packet is then delivered to the physical layer 410-1 for transmission to node 305-2. After the physical layer 410-2 of node 305-2 receives the RTS packet from node 305-1, node 305-2 sends the RTS packet to the data link layer 420-2 of node 305-2. The MAC layer in node 305-2, in concert with the physical layer 410-2, determines that the communication channel between the nodes 305-1 and 305-2 is not busy and generates a Clear-To-Send (CTS) packet for delivery from node 305-2 to node 305-1. The CTS packet is then delivered to the physical layer 410-2 for transmission to node 305-1.

If no other traffic is being transmitted by node 305-1, after receiving and processing the CTS packet from node 305-2, the MAC layer in node 305-1 removes the high priority data from the high priority traffic queue, generates a high priority MSDU and delivers the high priority MSDU to the physical layer 410-1 for transmission to node 305-2.

Consider now the FTP application 440-2 in node 305-2 which generates low priority data in the form of an SDU containing an FTP frame addressed to node 305-4. The low priority data are encapsulated in a TCP/IP packet. Upon receiving the low priority data containing the FTP frame, the routing protocol of the data link layer 420-2 determines that there is a communication route to the destination node 305-4 and the route requires that the low priority data be relayed through node 305-3. Therefore, the routing protocol delivers the low priority data to the MAC layer and requests delivery of the low priority data to node 305-4 through node 305-3. The MAC layer in the data link layer 420-2 of node 305-2 buffers the low priority data in a low priority traffic queue, which, in this example, is a non-real time traffic queue.

When the physical layer 410-2 in node 305-2 receives the high priority MSDU from node 305-1, node 305-2 passes the high priority data in the form of the VoIP SDU to the routing protocol in the data link layer 420-2. The routing protocol determines that the final destination for the high priority data is node 305-3 and that there is a communication route to node 305-3. In this case, node 305-3 is the next hop in the route. Therefore, the routing protocol delivers the high priority data to the MAC layer in node 305-2 and requests delivery of the high priority data to node 305-3. The MAC layer in node 305-2 strips off a MAC header and buffers the high priority data in the high priority traffic queue of node 305-2.

Node 305-2 now has data queued for transmission in both its high priority and low priority queues. The high and low priority data are destined for different nodes, i.e., node 305-3 and node 305-4, respectively, but the next hop along the communication route is the same, i.e., node 305-3. It is advantageous to use an RTS/CTS protocol to mitigate the aforementioned hidden node problem even when some of the data packets to be transmitted are very small, such as the high priority VoIP SDU packets in the present example. The present invention provides an efficient solution to the hidden node problem by aggregating both the high and low priority data to spread the bandwidth cost of the RTS/CTS packets.

Continuing with the present example concerning simultaneous transfer of both high priority and low priority data from node 305-2 to node 305-3, the MAC layer in node 305-2, in concert with the physical layer 410-2, next determines that the communication channel is not busy and generates a RTS packet for delivery to node 305-3. The RTS packet is then delivered to the physical layer 410-2 for transmission to node 305-3. After the physical layer 410-3 of node 305-3 receives the RTS packet from node 305-2, it sends the RTS packet to the data link layer 420-3 of node 305-3. The MAC layer in node 305-3, in concert with the physical layer 410-3, determines that the communication channel is not busy and generates a Clear-To-Send (CTS) packet for delivery to node 305-2. The MAC layer then delivers the CTS packet to the physical layer 410-3 for transmission to node 305-2.

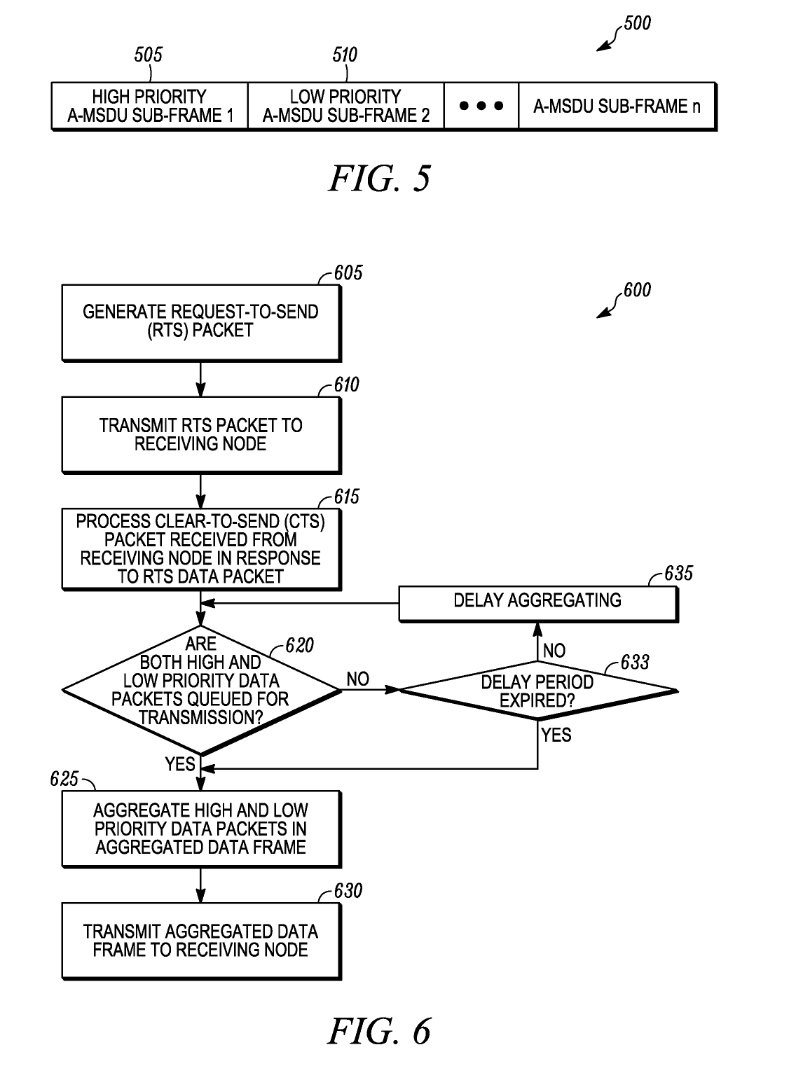

Referring to FIG. 5, a block diagram illustrates a sequence of sub-frames in an aggregated data frame that includes both high priority data and low priority data, according to some embodiments of the present invention. Since it is costly to mitigate the hidden node problem with the exchange of RTS/CTS packets, particularly for high priority and relatively small data packets such as VoIP SDUs, after receiving and processing the CTS packet from node 305-3, the MAC layer in node 305-2 removes both the high priority and low priority data from their respective traffic queues and constructs an aggregated data frame, such as an A-MSDU data frame 500, which aggregates both the high priority data and low priority data. The A-MSDU data frame 500 comprises at least one high priority A-MSDU sub-frame 505 and at least one low priority A-MSDU sub-frame 510. The A-MSDU data frame 500 is then delivered to the physical layer 410-2 for transmission to node 305-3.

When the physical layer 410-3 in node 305-3 receives the A-MSDU data frame 500 from node 305-2, it passes the A-MSDU data frame 500 to the data link layer 420-3 where it is de-aggregated and each A-MSDU sub-frame, including the A-MSDU sub-frame 505 and the A-MSDU sub-frame 510, is individually processed. The headers 210 transmitted with each A-MSDU sub-frame, including the A-MSDU sub-frame 505 and the A-MSDU sub-frame 510, of the A-MSDU data frame 500 enable the receiving node 305-3 to de-aggregate the high and low priority data. Since the destination of the high priority data in the A-MSDU sub-frame 505 in the form of the VoIP SDU is node 305-3, the high priority data are passed up to the VoIP application 440-3 in node 305-3. The low priority data containing the FTP TCP/IP frame encapsulated in the A-MSDU sub-frame 510 have node 305-4 as a destination. Therefore, the MAC header is stripped from the low priority data and the low priority data are passed to the routing protocol in the data link layer 420-3. The routing protocol determines that the final destination is node 305-4 and that there is a communication route to the destination node 305-4, which is the next hop in the route. Therefore, the routing protocol delivers the low priority data to the MAC layer and requests delivery of the low priority data to node 305-4. The MAC layer in node 305-3 then buffers the low priority data in the low priority traffic queue.

The process of delivering the low priority data packet to node 305-4 begins with the RTS/CTS packet protocol as described above in relation to transmission between nodes 305-1 and 305-2 and between nodes 305-2 and 305-3. The protocol is completed prior to transmitting the low priority data with an MSDU packet to node 305-4. After the low priority data are received at the node 305-4, and because node 305-4 is the destination node, the low priority data are passed up to the FTP application 440-4 for processing.

In the foregoing example, high priority data in the form of a VoIP SDU was already stored in the high priority queue of node 305-2. In addition, low priority data in the form of an FTP SDU was already stored in the low priority queue of node 305-2. Therefore, in accordance with embodiments of the present invention, the aforementioned aggregation of both high and low priority data to spread the bandwidth cost of the RTS/CTS packets of the present invention can be implemented.

However, in the event that only low priority data are queued in the low priority traffic queue of a node 305-n, the MAC layer of a node 305-n can delay transmission of the low priority data for a predetermined delay period. Hence, aggregation of data also can be delayed. Such a predetermined delay period, having for example a duration of 80 milliseconds, can provide sufficient time for high priority data, such as a VoIP SDU, to arrive in the high priority traffic queue of the same node 305-n. Once both queues have data to transmit, as described above, the MAC layer is then able to perform aggregation and construct an A-MSDU data frame 500 that contains both high priority and low priority data and deliver the A-MSDU data frame 500 to the physical layer 410-n for transmission to the next hop node 305-n along a route.

Similarly, it is possible to delay transmission of high priority data, such as a real time SDU, and await the arrival of low priority data, such as a non-real time SDU, or await the arrival of additional high priority data, such as another real time SDU. However, in this case, a predetermined delay period can be much smaller, such as 20 milliseconds, due to the QoS requirements of high priority data. If a predetermined delay period concerning high priority data is too large, transmission problems such as jitter can become significant. With a modest predetermined delay period, such as 20 milliseconds, the likelihood of high priority data becoming stale and being discarded is minimized. Nevertheless, such a modest predetermined delay period can be worthwhile since it can reduce the cost of using the RTS/CTS protocol while addressing the aforementioned hidden node problem.

Consider now a further example where one of the nodes 305-n shown in FIG. 3 and FIG. 4 is a receiving node that is operating in power save mode. In this example, the node 305-n can be either a destination node or a next hop in a communication route. According to embodiments of the present invention, transmission of the A-MSDU data frame 500 can be delayed until a predetermined time at which the receiving node operating in power save mode is scheduled to wake up. According to other embodiments of the present invention where a receiving node is operating in power save mode, transmission of the A-MSDU data frame 500 can be delayed until the sending node 305-n receives a trigger frame transmitted by the receiving node when the receiving node wakes up.

Referring to FIG. 6, a general flow diagram illustrates a method 600, from the perspective of a sending node, such as the node 305-2, for data transmission between nodes 305-n in the ad hoc wireless communication network 300, according to some embodiments of the present invention. At step 605, the sending node 305-2 generates a RTS packet and at step 610, the RTS packet is transmitted to the receiving node 305-3. At step 615, the sending node 305-2 processes a CTS packet received from the receiving node 305-3 in response to the RTS packet. At step 620, the sending node 305-2 determines whether both high priority data and low priority data are queued for transmission in the sending node 305-2. As described above, high priority data are queued in a separate queue from low priority data. At step 625, if both high priority data and low priority data are queued for transmission in the sending node 305-2, the sending node 305-2 aggregates the high priority data and the low priority data in an A-MSDU data frame 500. According to some embodiments of the present invention, aggregating is performed by a Medium Access Control (MAC) layer in the data link layer 420-n of the sending node 305-2. At step 630, the sending node 305-2 transmits the A-MSDU data frame 500 to the receiving node 305-3 where the aggregated data frame is de-aggregated and the high and low priority data contained in the A-MSDU data frame 500 are processed individually.

However, if it is determined at step 620 that both high priority data and low priority data are not queued for transmission in the sending node 305-2, then 14 the method 600 continues at step 633. According to some embodiments of the present invention, aggregating can be delayed until both the high priority data and the low priority data are queued for transmission or until a predetermined delay period has expired. In view of the QoS requirements for high priority data, such as real time data, according to some embodiments of the present invention, the predetermined delay period in aggregating generally can be for a longer time period when only low priority data are queued for transmission, and the predetermined delay period can be for a shorter time period when only high priority data are queued for transmission. If after the predetermined delay period both low priority data and high priority data are still not queued for transmission, then whichever data are queued will be transmitted without aggregation or further delay. Thus at step 633, it is determined whether a predetermined delay period has expired. If so, then the method 600 continues at step 625; if not, then at step 635 aggregating is delayed for the predetermined delay period.

As described above, FIG. 6 illustrates the transmission of an RTS packet (step 610) and processing of a CTS packet (step 615) prior to aggregation; however, as will be understood by those skilled in the art, these steps also can be executed after aggregating the high priority data and the low priority data as part of the transmit step 630.

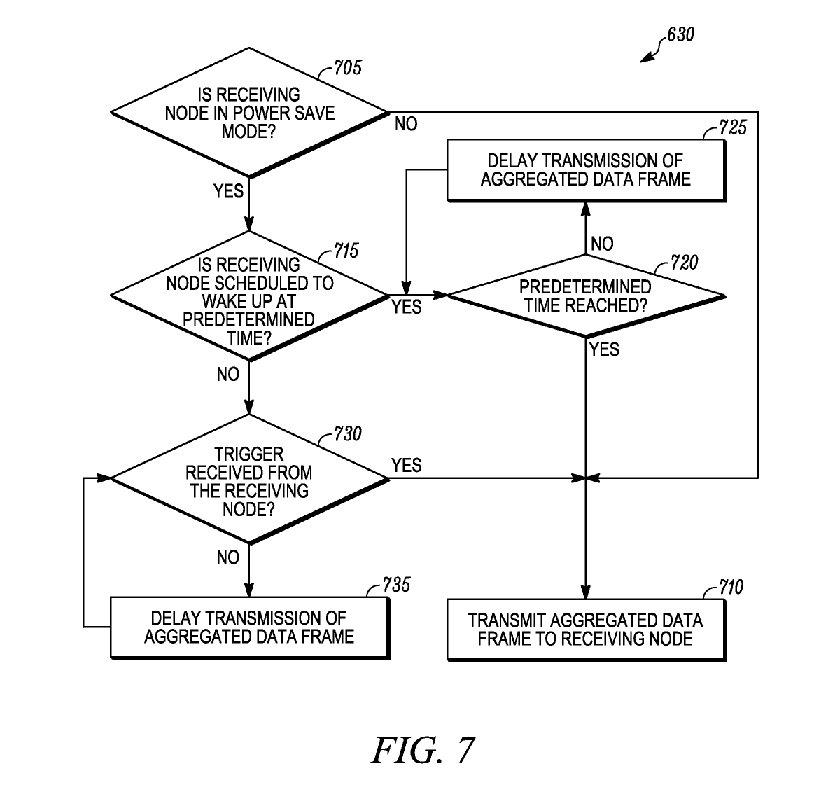

Referring to FIG. 7, a general flow diagram illustrates sub-steps of the step 630 of the method 600 concerning transmitting the A-MSDU data frame 500 to the receiving node 305-3, according to some embodiments of the present invention. At step 705, the sending node 305-2 determines whether the receiving node 305-3 is operating in power save mode. If the receiving node 305-3 is not operating in power save mode, then at step 710 the A-MSDU data frame 500 is transmitted to the receiving node 305-3.

However, if at step 705 it is determined that the receiving node 305-3 is operating in power save mode, then at step 715 the sending node 305-2 determines whether the receiving node 305-3 is scheduled to wake up at a predetermined time. If so, at step 720, the sending node 305-2 determines whether the predetermined time has been reached. If so, at step 710, the A-MSDU data frame 500 is transmitted to the receiving node 305-3. If the predetermined time has not been reached, the receiving node 305-3 is still in power save mode and, at step 725, transmission of the A-MSDU data frame 500 is delayed until the predetermined time is reached.

However, if at step 715 the receiving node 305-3 is not scheduled to wake up at a predetermined time, then at step 730, the sending node 305-2 determines whether a trigger frame has been received from the receiving node 305-3. A trigger frame can be transmitted, such as through a broadcast transmission to all nodes 305-n in the network 300, by the receiving node 305-3 when the receiving node 305-3 wakes up from a power save mode. If such a trigger frame has been received, then at step 710 the A-MSDU data frame 500 is transmitted to the receiving node 305-3. However, if at step 730 a trigger frame has not been received by the sending node 305-2, then at step 735 transmission of the A-MSDU data frame 500 is delayed until the sending node 305-2 receives a trigger frame.

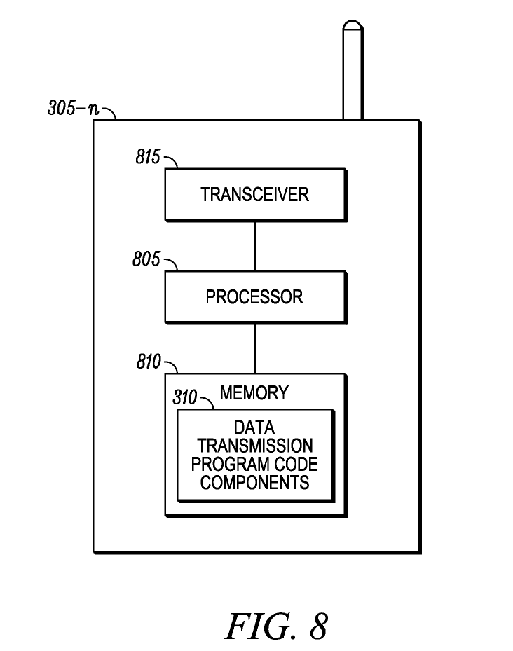

Referring to FIG. 8, a schematic diagram illustrates components of a node 305-n of the wireless communication network 300, according to some embodiments of the present invention. Those skilled in the art will recognize that the present invention can be embodied in a system of such a node 305-n, for example, in the form of a mobile telephone, notebook computer, two-way radio, personal digital assistant (PDA), or other wireless communication device. A system of a node 305-n can include a processor 805 such as a standard microprocessor or application specific integrated circuit (ASIC) operatively coupled to a memory 810. The memory 810 comprises a computer readable medium such as a random access memory (e.g., static random access memory (SRAM)), read only memory (e.g., programmable read only memory (PROM), or erasable programmable read only memory (EPROM)), or hybrid memory (e.g., FLASH) as is well known in the art. The computer readable medium then comprises the computer readable program code components 310 for data transmission that, when processed by the processor 805, are configured to cause the execution of the above described steps of the method 600. Communications such as those involved in the method 600 are then transmitted from or received by a transceiver 815 that is operatively coupled to the processor 805.

Advantages of the present invention thus include improved efficiency in an ad hoc wireless communication network that uses an RTS/CTS protocol to mitigate the hidden node problem. Overhead bandwidth of the RTS/CTS protocol is reduced by aggregating high priority data and low priority data in an aggregated data frame such as the A-MSDU data frame 500. The high priority data can include, for example, real time VoIP data and the low priority data can include, for example, non-real time data. Hence, the present invention enables the use of fewer RTS and CTS packets while still mitigating the hidden node problem.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We Claim:

1. A method for data transmission in an ad hoc wireless communication network, the method comprising:
determining whether both high priority data and low priority data are queued for transmission from a sending node to a receiving node;
aggregating the high priority data and the low priority data in an aggregated data frame when both high priority data and low priority data are queued for transmission; and
transmitting the aggregated data frame to the receiving node.

2. The method of claim 1, further comprising:
delaying aggregating the high priority data and the low priority data until both the high priority data and the low priority data are queued for transmission.

3. The method of claim 2, wherein aggregating the high priority data and the low priority data is delayed for a longer predetermined delay period when only low priority data are queued for transmission, and is delayed for a shorter predetermined delay period when only high priority data are queued for transmission.

4. The method of claim 1, further comprising:
delaying transmission of the aggregated data frame until the receiving node wakes up from a power save mode.

5. The method of claim 1, further comprising:
delaying transmission of the aggregated data frame until the sending node receives a trigger frame, where the trigger frame is transmitted from the receiving node when the receiving node wakes up from a power save mode.

6. The method of claim 1, wherein transmitting the aggregated data frame to the receiving node comprises transmitting a Request-to-Send (RTS) packet from a sending node to a receiving node, and processing a Clear-to-Send (CTS) packet received from the receiving node in response to the RTS packet.

7. The method of claim 1, wherein aggregating the high priority data and the low priority data is performed by a Medium Access Control (MAC) layer in the sending node.

8. The method of claim 1, wherein the high priority data are real time data.

9. The method of claim 1, wherein the low priority data are non-real time data.

10. A system for data transmission in an ad hoc wireless communication network, the system comprising:
computer readable program code components configured to cause determining whether both high priority data and low priority data are queued for transmission from a sending node to a receiving node;
computer readable program code components configured to cause aggregating the high priority data and the low priority data in an aggregated data frame when both high priority data and low priority data are queued for transmission; and
computer readable program code components configured to cause transmitting the aggregated data frame to the receiving node.

11. The system of claim 10, further comprising:
computer readable program code components configured to cause delaying aggregating the high priority data and the low priority data until both the high priority data and the low priority data are queued for transmission.

12. The system of claim 11, wherein aggregating the high priority data and the low priority data is delayed for a longer predetermined delay period when only low priority data are queued for transmission, and is delayed for a shorter predetermined delay period when only high priority data are queued for transmission.

13. The system of claim 10, further comprising:
computer readable program code components configured to cause delaying transmission of the aggregated data frame until the receiving node wakes up from a power save mode.

14. The system of claim 10, further comprising:
computer readable program code components configured to cause delaying transmission of the aggregated data frame until the sending node receives a trigger frame, where the trigger frame is transmitted from the receiving node when the receiving node wakes up from a power save mode.

15. The system of claim 10, wherein transmitting the aggregated data frame to the receiving node comprises transmitting a Request-to-Send (RTS) packet from a sending node to a receiving node, and processing a Clear-to-Send (CTS) packet received from the receiving node in response to the RTS packet.

16. The system of claim 10, wherein aggregating the high priority data and the low priority data is performed by a Medium Access Control (MAC) layer in the sending node.

17. The system of claim 10, wherein the high priority data are real time data.

18. The system of claim 10, wherein the low priority data are non-real time data.

19. The system of claim 10, wherein the high priority data are queued in a separate queue from the low priority data.

20. A system for data transmission in an ad hoc wireless communication network, the system comprising:
means for determining whether both high priority data and low priority data are queued for transmission from a sending node to a receiving node;
means for aggregating the high priority data and the low priority data in an aggregated data frame when both high priority data and low priority data are queued for transmission; and
means for transmitting the aggregated data frame to the receiving node.
